(19) United States
(12) Patent Application Publication
(10) Pub. No.: US 2021/0107072 A1
(43) Pub. Date: Apr. 15, 2021

(54) Router Bit Holding Vise

(71) Applicant: James Robert Miller, El Paso, TX (US)

(72) Inventor: James Robert Miller, El Paso, TX (US)

(21) Appl. No.: 16/597,023

(22) Filed: Oct. 9, 2019

(51) Int. Cl. B23C 5/24; B27C 5/10; B23C 5/10

(52) U.S. Cl. CPC B23C 5/24; B23C 5/10; B27C 5/10

(57) ABSTRACT

A router bit vise that holds and prevents the rotation of a router bit in a selected direction. It includes a tool housing and a cylindrical throughbore. Located in the throughbore is a one-way clutch assembly sized to accept a router bit shank. When inserted into the one-way clutch passageway, the router bit shank is engaged by the one-way clutch mechanism preventing movement in one rotational sense and allowing freewheeling movement in the opposite sense. No externally applied clamping force is required. With the router bit shank engaged with the one-way clutch circumferential rotation of the router bit is controlled allowing for bit maintenance, including cleaning, sharpening and most importantly enabling the application of the torque necessary to tighten or loosen a router bit fastener with no potential for shank slipping or damage.

### CROSS-REFERENCE TO RELATED APPLICATIONS

The present application claims priority to provisional patent application number 62/754,025 filed on Nov. 1,2018, disclosures of which are incorporated herein at least by reference.

### BACKGROUND OF THE INVENTION

### 1. Field of the Invention

The present invention is in the field of router bits and pertains particularly to controlling the rotation of the router bit shank.

### 2. Discussion of the State of the Art

Routers are tools used for removing material from a workpiece. The workpiece material is usually wood or metal but can be other natural or synthetic substances. Powered routers include a spindle that can be electrically, pneumatically, hydraulically, or manually rotated to spin an interchangeable router bit cutter. The router bit cutter is securely attached to the router spindle with a nut and sleeve compression system, referred to as a collet.

Router bit cutter constructions range from a single piece to those having multiple parts. One piece and multiple part router bits have one or more cutting edges and a central shaft or shank (usually ¼ inch or ½ inch diameter, but other shank diameters are commonly available). Furthermore, multiple part router bits can include elements mounted to the central shank and secured by a nut, screw, or similar fastening device. By removing the nut or screw and adding or subtracting bit elements such as cutters, guide bearings, spacers or shims, the amount and shape of the material removed in the routing process will be modified.

When performing assembly, set-up or disassembly of a stacked router bit the nut or cap screw or similar fastening device must be tightened or loosened. This function is often difficult due to the characteristics of the typical bit design. The problem that must be overcome is how to hold the router bit tight enough to resist the considerable torque necessary to unscrew or re-fasten the end nut, screw, or similar fastening device.

A common resolution to this problem has been to perform these operations mounted in the router's locked collet. Although the router collet effectively secures the bit, other problems are created. With the bit secured in the router collet the user often must contend with poor visibility and limited access. Another concern is the potential for small router bit parts, such as spacers, dust covers and washers to fall into the inverted spindle motor. Moreover, while using the router collet for set-up and maintenance the entire routing system is unavailable for use.

Other solutions to the problem of how to tightly hold the router bit are available but also have shortcomings. A popular but often ineffective approach is for the user to pad the router bit with a rag or similar material and grip this combination in hand chancing slipping and injury. A dangerous choice involves grasping the router bit with a gripping device such as a hand pliers, locking pliers or a bench vise. These devices have metal jaws which can score the shank causing damage and a potentially dangerous out-of-round condition. Conversely, when the jaws of these common gripping devices are padded or made of soft material, they often cannot provide sufficient holding force necessary to loosen or re-fasten the end nut or screw.

Prior art has been offered that attempt to address some of these router bit tool holding issues, but all have significant shortcomings. For example, Valfor Tools offers a router bit vise that utilizes a split bore that clamps the bit when pulled together with a fastener. The fatal flaw of this invention requires the user to arbitrarily determine the proper clamping torque. If too little torque is applied the router bit shank can slip causing shank damage. Too much torque will damage the device. In addition, if the bit needs to be repositioned after the clamping screw has been tightened it must be loosened and retightened.

Therefore, what is clearly needed is a router bit holding vise that solves the problems mentioned above.

### SUMMARY OF THE INVENTION

In one embodiment of the invention a router bit vise for holding and preventing the rotation of a bit for a took especially a multiple part router bit, in a selected direction is provided comprising a generally rectangular tool housing with an axial cylindrical through-bore transverse to the planar surfaces of said housing. Coaxially located in the through-bore is a one-way clutch assembly with an open-ended passage, sized to retain and engage the router bit, and specifically the router bit shank, perpendicular to the planar surfaces of the housing. Also in one embodiment the tool housing can be used as a hand-held device, mounted to an external surface or held in a bench vise or similar clamping system.

Also in one embodiment a one-w ay bearing mechanism engages the shank of an inserted router bit preventing rotation of the bit in a selected sense, but the bit can be circumferentially repositioned, without the use of tools, clamps, or adjustment by rotating the router bit in the opposite sense. With the shank of the bit inserted in the axial passageway of the one-way clutch, rotation in one sense is prevented and torque can be applied to a router bit fastener resulting in a tightening or loosening of said router bit fastener.

Also in one embodiment of the invention a plurality of router bit shank sizes can be comprised in a single housing by the addition of multiple through-bores transverse to the housing planar surfaces with different diameters sized to accept one-way clutch assemblies with clutch axial passageways that correspond to the diameter of any router bit shank diameter.

In a further embodiment of the invention said router bit shank will not move when turned in one sense but turn freely in the opposite sense. This eliminates the potential for damage to the router bit fastener screw threads that could occur if the application of torque to the fastener is in the wrong direction.

In another aspect of the invention a method for holding and preventing the rotation of a router bit in a selected direction is provided comprising, the steps (a) secure the housing with axial through-bore by hand grip, fastened to a surface or secured with a clamping device, (b) select the side of the housing (and one-way clutch assembly) that is indicated to support the desired loosening or tightening activity, (c) insert the router bit shank into the axial passageway of the one-way clutch assembly, (d) insertion from the front planar face (“Tight” side) of the housing of into the clutch mechanism will prevent rotation of the router bit allowing a bit fastener to be tightened, (e) transversely, insertion of a router bit shank into the axial bore from the rear planar face (“Loose” side) of the housing into the clutch mechanism will prevent rotation of the router bit in the opposite rotational sense allowing a bit fastener to be loosened. Also, in one embodiment of the method with the shank inserted into the clutch passageway from the face indicated, bit disassembly and/or cleaning, and/or sharpening, and/or reassembly is automatically supported without tools or adjustments.

Also in embodiment of the method with the router bit shank engaged with the one-way clutch, circumferential rotation of the router bit is controlled enabling the application of the torque necessary to tighten or loosen a router bit fastener.

### BRIEF DESCRIPTION OF THE SEVERAL VIEWS OF THE DRAWINGS

In the detailed description which follows reference will be made to the drawing comprised of the following figures.

FIG. 1 is a partially exploded isometric view of a router bit vise according to an embodiment of the present invention.

FIG. 2 is a side elevation of one embodiment of a typical multiple part router bit.

FIG. 3 is a perspective view of a one-way clutch mechanism as comprised in the embodiment of the invention of FIG. 1.

FIG. 4 is an end view of the embodiment of a one-way clutch mechanism as comprised in the embodiment of the invention of FIG. 1.

FIG. 5 is a cross sectional view of a one-way clutch mechanism for the embodiment of FIG. 4 taken along section line A-A.

FIG. 6 is a partially exploded isometric view of a router bit vise according to an embodiment of the present invention of FIG. 1 comprised of a multiple part router bit of FIG. 2.

FIG. 7 is a side view of the router bit vise of FIG. 1 comprised of a typical multiple part router bit of FIG. 2.

FIG. 8 is a front view (“tight” side) of a router bit vise of the invention of FIG. 1.

FIG. 9 is a top view of the router bit vise of the invention of FIG. 1 comprised of a typical multiple pan router bit of FIG. 2 inserted from the front (“tight”) side of FIG. 1.

FIG. 10 is a front view of the router bit vise of FIG. 7 with a hex wrench engaging a router bit fastener.

FIG. 11 is a back view (“loose” side) of the invention of FIG. 1.

FIG. 12 is a top view of the router bit vise of the invention of FIG. 1 comprised of a typical multiple part router bit of FIG. 2 inserted from the hack (“loose”) side of FIG. 1.

FIG. 13 is a back view (“loose” side) of the embodiment of the invention of FIG. 1 with a hex wrench engaging a router bit fastener.

FIG. 14 is a partially exploded isometric view of an alternative embodiment of the invention.

FIG. 15 is a front view (“Tight” side) of FIG. 14.

FIG. 16 is a back view (“Loose” side) of FIG. 14.

FIG. 17 is a side view of FIG. 14.

### DETAILED DESCRIPTION OF THE INVENTION

The inventor provides a unique system to control the rotation of a router bit during adjustment, maintenance, setup and related activities. The invention employs a novel application of a one-way bearing functioning as a router bit vise that requires no adjustment, screws, clamps or jaws. The present invention is described in enabling detail in the following examples, which may represent more than one embodiment of the present invention.

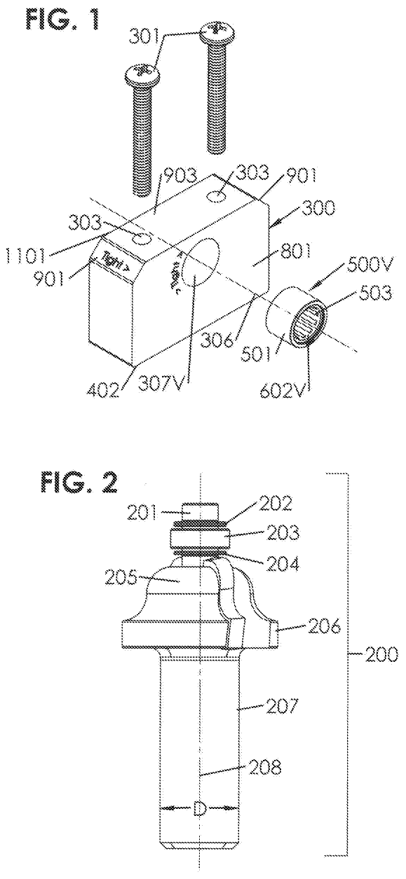

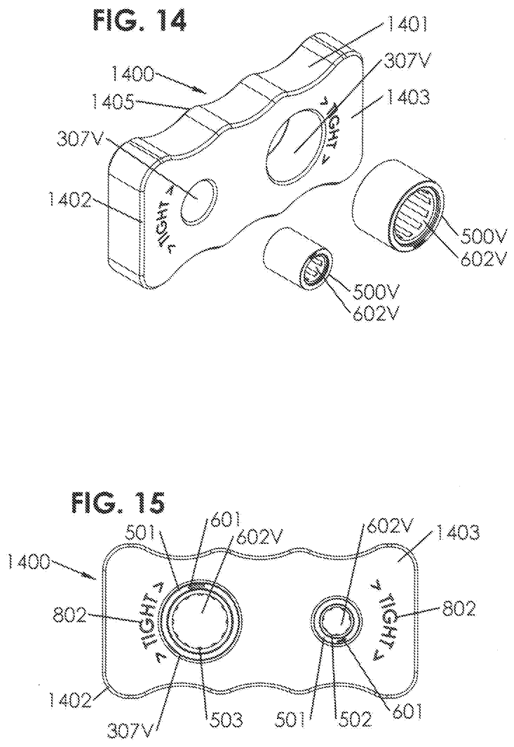

FIGS. 1-13 generally illustrate an embodiment of the invention that include views of various component and complimentary parts. The remaining FIGS. 14-17 illustrate another embodiment of the present invention.

FIG. 1 is a partially exploded isometric view of a router bit vise according to an embodiment of the present invention. In this example a tool housing 300 includes an axial uniform diameter cylindrical through-bore 307V (hereafter named through-bore) having a centerline axis 306. The tool housing 300 is fabricated from a strong durable material such as aluminum, steel, or plastic. The tool housing 300 is comprised of a first generally planar outer surface (>Tight>) side 801 which is transverse to the centerline axis 306 and a second generally planar outer surface (<Loose<) side 1101 also transverse to the centerline axis 306. The tool housing 300 is sized so that it may be manually grasped on the outer surfaces which are comprised of, first generally planar outer surface (>Tight>) side 801, second generally planar outer surface (<Loose<) side 1101 and the housing top surface 903. Another operator option available with this embodiment allows the user is to secure the tool with an external damping device such as a bench vise or “c” clamp by clenching the first generally planar outer surface (>Tight>) side 801 and second generally planar outer surface (<Loose<) side 1101 below the through-bore 307V. A further user option provided by this example is to attach the tool to an external planar surface such as a workbench through a pair of mounting fastener apertures 303. Each of the mounting fastener apertures 303 consists of a through-bore that extends from the housing top surface 903 through to the housing bottom surface 402 of the tool housing 300. The mounting fastener apertures 303 in the tool housing 300 are located proximate to the top ends thereof near where each end of the tool housing 300 has been beveled. Each of the mounting fastener apertures 303 has been configured with a bore large enough to receive a mounting fastener 301 therethrough sized to firmly attach the tool to afore mentioned external planar surface. When each mounting fastener 301 has been inserted through the mounting fastener apertures 303 and driven into a workbench or other planar surface the tool housing will not move in response to set-up pressures or applied torque. The through-bore 307V in this embodiment is sized to accept a one-way clutch assembly 500V. The one-way clutch assembly 500V comprises a one-way clutch housing 501 and includes a set of multiple clutch rollers 503 which form a clutch axial passageway 602V. The one-way clutch assembly 500V and specifically the clutch axial passageway 602V that, when assembled into the through-bore 307V of the tool housing 300, is coaxial with the axis of the through-bore 307V. Various combinations of a compatibly sized one-way clutch assembly 500V. clutch axial passageway 602v. and through-bore 307V are possible.

FIG. 2 is a side elevation of one embodiment of a typical multiple part router bit 200. A typical multiple part router bit 200 is comprised of a router bit body 205 which is symmetrical about a router bit centerline axis 208 as is a ground router bit shank 207. The normally ground router bit shank 207 is commonly available with a variable router bit shank diameter D in a multiplicity of imperial and metric dimensions. According to this embodiment additional components of a multiple part router bit 200 can be comprised of, but not limited to, a router bit washer 202, a guide bearing 203, a dust shield 204, a sharp router bit cutting edge 206 and a router bit fastener 201. The router bit fastener 201 is an essential component of a multiple part, router bit 200 designed to compress and retain the position and integrity of the various router bit components. A router bit fastener often comprises an externally threaded screw but can also include an internally threaded nut or lock nut. Common in all router bit designs, as in this example, the router bit fastener 201 must be capable of withstanding the torque values required to apply, retain and release the component parts of a multiple part router bit 200. To accomplish the application or release of torque, the router bit fastener must be tightened or loosened. To do so, the multiple part router bit 200 and particularly the router bit shank 207 must be prevented from rotating in the direction to which torque is applied to the router bit fastener 201. Preventing the router bit front rotating in the direction that the tightening or loosening torque is applied while allowing free movement in the opposing direction without requiring any adjustment is the major contribution of the present invention.

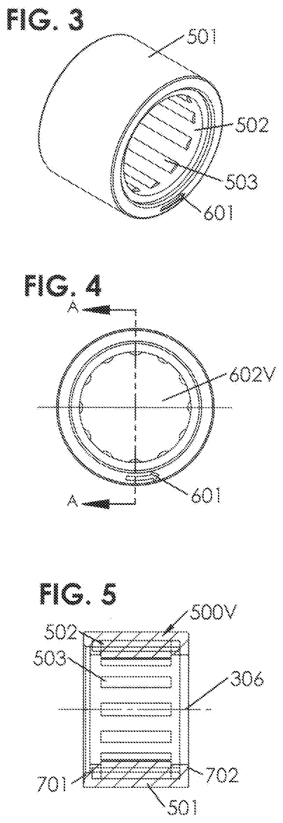

Referring to FIGS. 3-5; FIG. 3 is a perspective view of a one-way clutch assembly as comprised in the embodiment of the invention of FIG. 1. FIG. 4 is an end view of the embodiment of a one-way clutch assembly for the router bit vise of FIG. 1. FIG. 5 is a cross sectional view of a one-way clutch assembly for the embodiment of FIG. 4 taken along section line A-A. The one-way clutch assembly 500V of FIGS. 3-5 provides an example of one type of a common one-way clutch design generally identified as the HF version of a one-way clutch. It should be understood that there are many alternative one-way clutch designs that can be incorporated into the present invention. Examples of alternative one-way clutch designs that can be incorporated into the present invention include, but are not limited to, HF, RCB, FC, RC, HFL and FCB configurations. The one-way clutch assembly 500V and, specifically, a one-way clutch housing 501 is sized for press fit compatibility with the through-bore 307V of the tool housing 300. The one-way clutch assembly 500V and more particularly, the one-way clutch housing 501 includes transverse end flange 701 and transverse end flange 702 to facilitate the retention of a one-way clutch mechanism 502. The one-way clutch mechanism 502 typically includes rollers, such as the multiple clutch rollers 503 which interact with a cylindrical router bit shank 207 that may be inserted in the clutch axial passageway 602V. When the router bit shank 207 is inserted into the clutch axial passageway 602V the interface between the one-way clutch mechanism 502 and the router bit shank 207 automatically initiate the prevention of rotation in one sense but allows free movement when rotated in the opposite sense. The HF version of a one-way clutch in the embodiment of FIGS. 3-5 is generally marked on one side with a directional arrow 601. The directional arrow 601 illustrates the rotational sense imparted to an inserted cylindrical member such as a router bit shank 207 positioned in the clutch axial passageway 602V. The directional arrow 601 thereby indicates the direction in which an inserted cylindrical member will freely rotate. In this example a router bit shank 207 can freely rotate when turned in the sense indicated by the directional arrow 601 but is firmly engaged and gripped by the one-way clutch mechanism 502 when rotation is initiated in a sense opposite that indicated by the directional arrow 601.

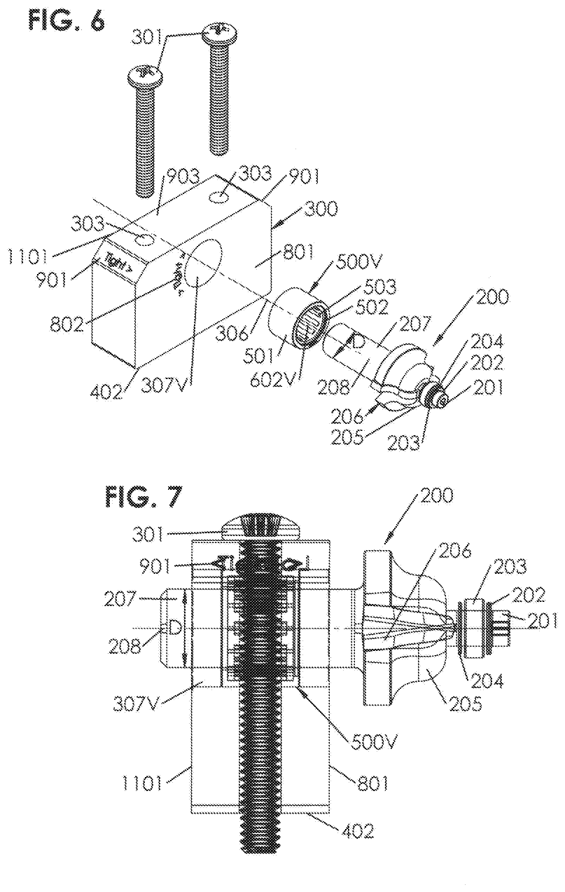

FIGS. 6-9 provide views that illustrate the relationship between the depiction of a typical router bit of FIG. 2 and the embodiment of the invention of FIG. 1. FIG. 6 is a partially exploded isometric view of a router bit vise according to an embodiment of the present invention of FIG. 1 comprised of a typical multiple part router bit of FIG. 2.

FIG. 7 is a side view of the router bit vise of FIG. 1. comprised of a typical multiple part router bit of FIG. 2. Referring to FIG. 6 and 7 the tool housing 300 includes a through-bore 307V having a centerline axis 306. The tool housing 300 and through-bore 307V incorporates a one-way clutch assembly 500V. The combination of the through-bore 307V and one-way clutch assembly 500V cooperate with the variable router bit shank diameter D on a common centerline axis 306. That is, a through-bore 307V of different sizes, in combination with a compatibly sized one-way clutch housing 501 and one-way clutch assembly 500V define an important aspect of this invention. As illustrated in the examples of FIGS. 6-7 a one-way clutch mechanism 502 of a one-way clutch assembly 500V is sized to cooperate with a variable router bit shank diameter D to fit into the clutch axial passageway 602V. Thus, when the diameter of a multiple part router bit 200, and, more particularly, the router bit shank 207 is selected such that the sides of the router bit shank 207 engage the multiple clutch rollers 503 of the one-way clutch assembly 500V the rotation of the router bit will turn freely in one direction and cannot turn in the reverse direction.

Therein lies the benefit of the invention and the use of the one-way clutch assembly 500V. Reversal of rotation from a restricted sense to a freewheeling sense provides the added advantage of allowing the user the ability to manipulate the router bit body 205 and router bit cutting edge 206 without the need to release and/or readjust any additional restraints or clamping fixtures. Further, with the router bit shank 207 inserted into the one-way clutch axial passageway 602V in the direction appropriate for the desired router bit fastener tightening or loosening operation, rotation in the selected direction is prevented and adequate torque to manipulate a router bit fastener 201 can be applied.

FIG. 8 is a front view (“tight”side) of the router bit vise of the invention of FIG. 1. In one example on the first generally planar outer surface (>Tight>) side 801 of the tool housing 300 circumferentially adjacent to the through-bore 307V that contains the one-way clutch assembly 500V is a >Tight> turn direction indicator 802. The >Tight> turn direction indicator 802 is in opposition to the directional arrow 601 that appears on the one-way clutch housing 501.

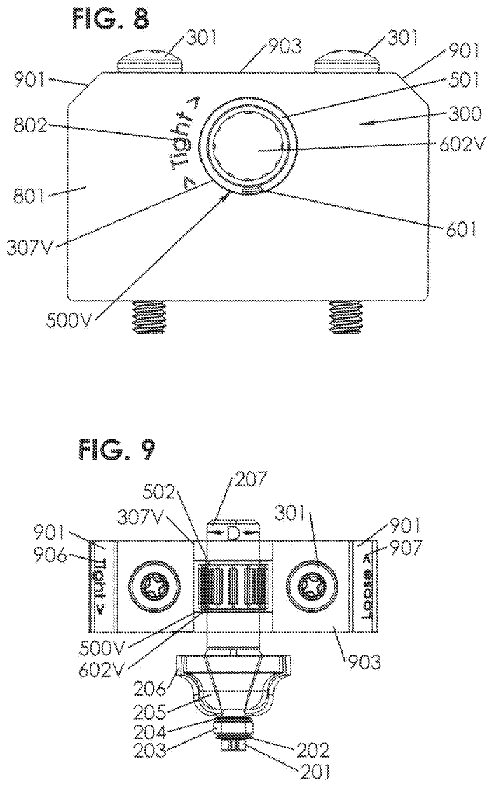

FIG. 9 is a top view of the router bit vise of the invention of FIG. 1 comprised of a typical multiple pan router bit of FIG. 2 inserted into the one-way clutch axial passageway 602V from the first generally planar outer surface (>Tight>) side 801 of the tool housing 300. Marked on a chamfered top corner 901 of the tool housing 300 is the tight insertion direction indicator 906 further advising the user of the correct planar outer surface that the router bit shank 207 must be inserted into the clutch axial passageway 602V for the one-way clutch mechanism 502 to grip the router bit shank 207 allowing tightening torque to be applied to the router bit fastener 201.

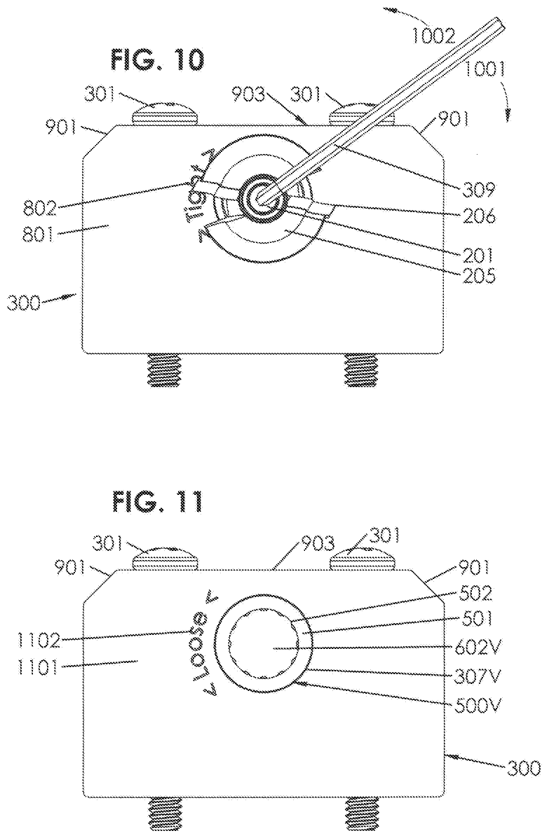

FIG. 10 is a front view of the bit vise of FIG. 7 with a hex wrench 309 engaging a router bit fastener 201. As designated by the >TIGHT> turn direction indicator 802 marked on the first generally planar outer surface (>Tight>) side 801 of tool housing 300 the shank of the router bit is gripped by the mechanism of the one-way clutch assembly and as such cannot rotate when torque is applied in a clockwise direction to the router bit fastener 201. Thus, clockwise rotation 1001 of the hex wrench 309 when engaged with the router bit fastener 201 will cause only the router bit fastener 201 itself to rotate and consequently result in the fastener being tightened. Reverse or counterclockwise rotation 1002, however, is freewheeling. This feature allows for easy repositioning of the router bit cutting edge 200 and other router bit elements improving access and visibility to facilitate setup and maintenance procedures. That ability, to allow the fastener to be tightened only when the router bit shank 207 is inserted as directed, is a unique benefit associated with the use of a one-way clutch.

FIG. 11 is a back view (“Loose side”) of the invention of FIG. 1. In this example the second generally planar outer surface (“Loose side”) 1101 of the tool housing 300 circumferentially adjacent to the through-bore 307V that contains a one-way clutch assembly 500V is a <loose< turn direction indicator 1102. The <Loose< turn direction indicator 1102 identifies the direction that the one-way clutch assembly will grip a router bit shank. With the router bit prevented from turning in a counter clockwise direction a router bit fastener can be loosened. In the opposite sense, the shank of the router bit is freewheeling in the alternate direction.

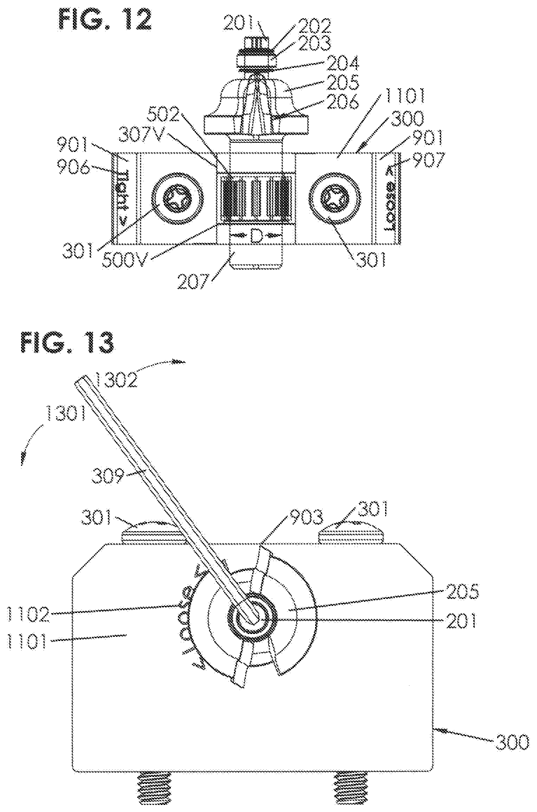

FIG. 12 is a top view of the router bit vise of the invention of FIG. 1 comprised of a typical multiple part router bit of FIG. 2 inserted into the one-way clutch axial passageway from the second generally planar outer surface (<Loose<) side 1101 of the tool housing 300. Marked on a chamfered top corner 901 of the tool housing 300 is the Loose insertion direction indicator 907 further advising the user of the correct planar outer surface and the direction from which the router bit shank 207 must be inserted into the clutch axial passageway 602V for the one way clutch mechanism 502 to grip the router bit shank 207 allowing counter clockwise (Loosening) torque to be applied to a router bit fastener 201.

FIG. 13 is a back view of the embodiment of the invention of FIG. 1 with a hex wrench 309 engaging a router bit fastener 201. As designated by the <Loose< turn direction indicator 1102 marked on the second generally planar outer surface 1101 of tool housing 300 the shank of the router bit is gripped by the one-way clutch mechanism of the one-way clutch assembly and as such is prevented from rotating when torque is applied in a counter clockwise rotation 1301 to the router bit fastener 201. Thus, counter clockwise rotation 1301 of the hex wrench 309 engaging the router bit fastener 201 will cause only the fastener itself to rotate and consequently result in the fastener being loosened. Reverse rotation 1302 of the hex wrench 309, however, is freewheeling eliminating the possibility of accidentally turning the fastener in the wrong direction potentially causing damage to a router bit body 205 or a router bit fastener 201 which is another important attribute of the present invention. Additionally, this freewheeling feature allows for easy repositioning of the router bit body 205 for improved access when performing sharpening, cleaning and setup operations.

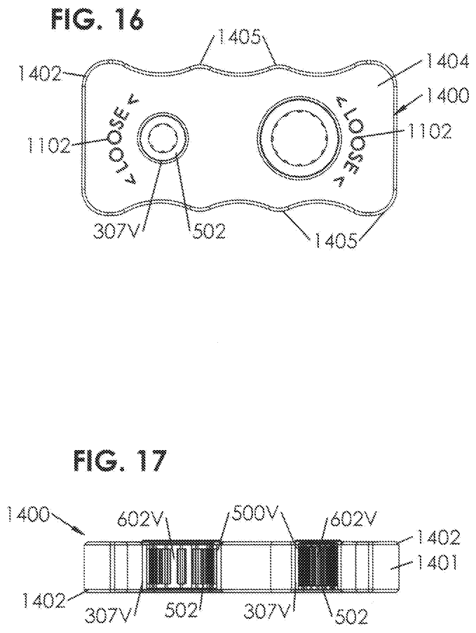

FIGS. 14-17 comprise an optional construction of an embodiment of the present invention illustrating a further example of a tool holder comprised of multiple through-bores and one-way clutch assemblies. FIG. 14 is a partially exploded isometric view of an alternative embodiment of the invention. FIG. 15 is a front view (“Tight” side) of FIG. 14. FIG. 16 is a back view/“Loose” side) of FIG. 14. FIG. 17 is a side view of FIG. 14. This alternative embodiment of the present invention is primarily intended as a hand-held device with undulating edges 1401 machined into the long sides of the generally rectangular holder to enhance user grip and control. All edges of the example have a chamfer 1402 to enhance user comfort. Although the long sides of the tool housing are contoured, the peak of each undulation high point 1405 is symmetrical with the opposing side to allow the housing to be clenched in a parallel jaw clamp or bench vise. The tool housing in this embodiment of the invention is constructed of aluminum but can be produced from any dimensionally stable material such as steel, plastic or brass. The multiple through-bores 307V are sized to accommodate different one-way clutch assemblies 500V, and more particularly, one-way clutch assemblies 500V with different one-way clutch axial passageways 602V. This alternative embodiment of a ripple grip tool housing 1400 can be appropriately sized to incorporate two or more axial uniform diameter cylindrical through-bores 307V. Within the multiple uniform diameter axial through-bores 307V of the scalloped edge tool housing 1400 each one-way clutch assembly 500V installed in the multiple bore first planar surface “>Tight>” side 1403 has an identical rotational orientation. For example, all one-way clutch assemblies that face the multiple bore first planar surface “>Tight>” side 1403 are oriented to prevent rotation when the multiple part router bit 200 is turned in a clockwise sense. Conversely each one-way clutch assembly 500V installed facing the multiple bore second planar surface “Loose” side 1404 of the ripple grip tool housing 1400 will have an identical but reversed rotational orientation. One-way clutch assemblies that face the multiple bore second planar surface “Loose” side 1404 are oriented to prevent rotation when the multiple part router bit 200 is turned in the counter clockwise sense. In another embodiment of the present invention tine number of router bit diameters that can be incorporated into a single ripple grip tool housing 1400 is determined by the size of the planar faces of the tool housing and the number of through-bores with installed one-way clutch assemblies 500V provided.

Appreciate that tins invention is not limited to the embodiments noted and that changes and modifications to the system and method described herein may be made without departing from the invention. For example, according to a further embodiment of the present invention stacking two one-way clutches in opposing rotational directions in the same uniform diameter cylindrical through-bore will prevent router bit shaft rotation in both clockwise and counter clockwise directions.

Regardless of the application variations, the utilization of a one-way clutch is an important feature of this invention providing for the positive interaction preventing rotational movement in a desired directional sense. The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise, it will be further understood that the terms “comprise” and/or “comprising,” when used in this specification, specify the presence of stated features, steps, operations, elements, components and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant an and the present disclosure and will not be interpreted in an idealized or overly formal sense unless expressly so defined herein.

In describing the invention, it will be understood that a number of techniques and steps are disclosed, Each of these has individual benefit and each can also be used in conjunction with one or more, or in some eases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

1. A router bit vise for holding and preventing the rotation of a bit for a tool, especially a multiple part router bit, in a selected direction comprising:
a generally rectangular tool housing with two generally planar outer surfaces and an axial uniform diameter cylindrical through-bore transverse to the planar surfaces;
a one-way clutch assembly including a generally cylindrical clutch housing and an internal one-way clutch mechanism with an axial open-ended passage, said one-way clutch mechanism generally coaxially located in said axial uniform diameter cylindrical throughbore of said tool housing; and
an axial passageway of the one-way clutch mechanism sized to accept the insertion of a cylindrical router bit shank having a circumferential surface for locking clutch engagement with said clutch mechanism upon attempting rotation of said router bit shank about the axis of said passage in one rotational sense, and freewheeling movement in the opposite rotational sense, said router bit shank having an axial dimension greater than the axial dimension of said axial passage,
a generally cylindrical bore sized to accept a one-way clutch mechanism with an axial passage-way sized to retain the router bit perpendicular to the planar surfaces of the housing.

2. The device of claim 1 wherein the tool housing affords variable use options comprising;
a stationary device that can be mounted to an external surface;
a hand-held device
a temporarily fixed device held in a bench vise or other type of clamping system.

3. The device of claim 1 wherein a one-way bearing mechanism will provide locking clutch engagement of an inserted router bit shank preventing rotation of the bit in a selected direction facilitating the application of torque to a router bit fastener for the purpose of the tightening or loosening of said router bit fastener.

4. The device of claim 1 wherein a router bit is prevented from rotating in a selected sense but can be circumferentially repositioned, without the use of tools, by rotating the router bit in the opposite sense.

5. The device of claim 1 wherein the housing through-bore, the one-way clutch assembly and in particular the clutch axial passageway can be individually sized to accept a multiplicity of router bit shank diameters.

6. The device of claim 1 wherein insertion of the router bit into the clutch axial passageway automatically engages the one-way clutch mechanism preventing circumferential movement of the router bit shaft in the selected rotational sense and allowing freewheeling circumferential movement in the opposite sense.

7. The device of claim 1 wherein the embodiment of the present invention requires no adjustments eliminating the potential for shank damage or slippage caused by the application of too much or too little clamping pressure.

8. The device of claim 1 wherein the housing can be configured with contoured sides that provides finger grooves to enhance grip and control.

9. The device of claim 1 wherein all edges of the housing are chamfered to enhance user grip and diminish potential for injury.

10. The device of claim 1 wherein said clutch assembly comprises a separate component affixed in an axial passageway of said holder.

11. The device of claim 1, wherein the router bit shank, after insertion into the one-way clutch axial passageway, requires no externally applied clamping pressure on the router bit shaft to prevent router bit rotation in the selected direction when inserted into the one-way clutch through-bore.

12. The device of claim 1 wherein removal of the router bit from the one-way clutch assembly in this embodiment of the present invention is accomplished without tools, adjustments or release of holding or clamping systems.

13. The device of claim 1 wherein a plurality of router bit shank sizes can be comprised in a single housing by providing multiple axial uniform diameter cylindrical through-bores transverse to the planar surfaces of the housing wherein are contained one-way clutch assemblies with clutch axial passageways that correspond to the diameter of a multiplicity of router bit shank diameters.

14. The device of claim 1 wherein smooth and precise rotation in the freewheeling direction provided by the one-way clutch mechanism permits unrestricted radial positioning and manipulation of the router bit without the need for release of a clamping mechanism.

15. The device of claim 1 wherein the router bit shank will not move when turned in one sense but turn freely in the opposite sense eliminating the potential for damage to the router bit fastener screw threads resulting from the application of torque in the wrong direction.

16. A method for holding a router bit and selectively preventing rotation in either clockwise or counter clockwise rotational sense comprising the steps of:
(a) secure the housing with axial through-bore by hand grip, fastened to a surface or held with a clamping device;
(b) choose the through-bore with one-way clutch axial passageway sized to accept the insertion of a particular router bit shank diameter;
(c) select the housing planar face that indicates compatibility with the desired router bit maintenance activity;
(d) insert the shank of the router bit from the generally planar outer surface (“Tight” side) of the housing into the clutch axial passageway of the one-way clutch mechanism preventing rotation of the router bit in a clockwise direction to tighten a bit fastener;
(e) insert a router bit shank from the generally planar outer surface (“Loose” side) of the housing into the axial passageway of the one-way clutch mechanism to prevent rotation of the router bit in a counter clockwise (opposite rotational sense) to loosen a bit fastener;
(f) remove the router bit from the router bit vise by pulling the bit from the clutch axial passageway in the opposite sense of the step (d) insertion without tools or adjustments

17. The method of claim 16 wherein the one-way clutch mechanism of steps (d) and (e) engage the shank of an inserted router bit preventing rotation of the bit in a selected sense, but the bit can also be circumferentially repositioned, without the use of tools, clamps, or other adjustment by rotating the router bit in the opposite sense.

18. The method of claim 16 wherein the one-way clutch mechanism of steps (d) and (e) engages the shank of an inserted router bit preventing rotation of the bit in a selected sense but will turn freely in the opposite sense eliminating the potential for damage to router bit fastener screw threads if torque is applied to the bit fastener in the wrong direction.
